(19) United States
(12) Patent Application Publication
(10) Pub. No.: US 2008/0126959 A1
(43) Pub. Date: May 29, 2008

(54) MANAGEMENT OF TEMPORARY APPLICATION PROGRAM SETTINGS

(76) Inventors: INDRAN NAICK, Cedar Park, TX (US); Cheranellore Vasudevan, Austin, TX (US)

Correspondence Address: IBM CORPORATION (SS), C/O STREETS & STEELE, 13831 NORTHWEST FREEWAY, SUITE 355, HOUSTON, TX, 77040, US

(21) Appl. No.: 11/564,565

(22) Filed: Nov. 29, 2006

(51) Int. Cl. G06F 3/00

(52) U.S. Cl. 715/764

(57) ABSTRACT

Method for managing temporary settings in an application program and a computer program product including instructions embodied on a computer readable medium for performing the method. The method detects entry of a new application setting, then automatically queries a user to designate the new setting as a default setting or a temporary setting. If the new setting is designated as a temporary setting, then the method automatically queries the user to designate an expiration condition. The application program subsequently uses the temporary setting until occurrence of the expiration condition. In response to the occurrence of the expiration condition, the application program operates using the default setting. Examples of an expiration condition include a time period or an event, such as closing a task pane, closing a document, closing the instantiation of the application, or using the temporary setting more than a set point number of times.

### BACKGROUND OF THE INVENTION

1. Field of the Invention

The present invention relates to the management of application program settings.

2. Background of the Related Art

A wide variety of application programs have been developed to help users accomplish a wide variety of tasks. It is common for a particular application program to include optional or alternative features that allow a user to work in a convenient and efficient manner for performing their desired task. Since a particular user or group of users may repeat a task or perform several related tasks, application programs will typically provide multiple user-settable parameters or settings that control the use of the optional or alternative features. Accordingly, the settings are maintained and stored by the application program, but may be changed by the user when desired. However, unless the user makes an intentional change to the settings, the application program will consistently operate in accordance with the user settings. For example, the user may open the application program and be presented with the same graphical interface as previous sessions because the graphical interface is manifested in accordance with various settings, such as a grouping of feature icons or the format and content of a window.

User settings are distinct from a hardware configuration. Whereas an application program may need information about a hardware configuration in which it will operate, the hardware configuration is more or less static and does not need to be altered except when the hardware has been replaced or updated. User settings are those aspects of the application program that are determined at the user's discretion and may be changed seldomly or frequently depending upon the user's preferences and tasks. User settings may include, without limitation, both application settings and document settings. An application setting is a setting that is applied anytime that the application is in use, regardless of the particular document or file that is opened. By contrast, a document setting is a setting that is specific to a particular document or file, but is not applied to a subsequent document or file within the same application program.

User settings are typically accessed and entered through a menu system, such as a menu bar with drop-down boxes, a menu bar or pallet with selected feature icons, or a drop-down box initiated with a right-click on a mouse. However, certain settings may be determined during the initial setup of the application program. For example, a setup process may give the user or system administrator an opportunity to select various default settings or a group of default settings that may be representative of the types of tasks that the user intends to accomplish with the application program. For example, a setup process for a graphics application program may query whether the user intends to prepare technical manufacturing drawings akin to “blueprints” or colorful sales brochures. Based upon the user's response, the application program can implement a group of settings that are intended to enable features and set parameters in a manner most likely to assist the user. Still, the user may alter these settings to enable or disable features, change parameters and otherwise customize the application program for their purposes.

The settings that are in use by an application program are stored in a computer readable medium for use by the application program from one user session to another. Typically, the file in which the settings are stored is referred to as the configuration file. The form, name and location of a configuration file are usually specific to the associated application program.

An application program may utilize the settings in the configuration file during startup of the application program in order to extend the application to the user in the desired manner. If the application program supports multiple users over a network, individual users may access the application program and instantiate a separate interface that represents their own settings. Similarly, an application may refer to the settings in the configuration file at the time that a particular feature is called upon by the user. For example, when a user activates a spell checking feature of a word processing application program, that program may first look at the configuration file to determine whether the user settings indicate that misspelled words should be automatically corrected, what format should be used to highlight the misspelled words, and whether words in all capital letters should be ignored.

While the utility of settings is unquestionably beneficial, there are still shortcomings in the manner with which users interact with settings. One problem is that the value of a particular setting may not be readily apparent during use of the application program and the value or availability of the particular setting may be unknown to the user or forgotten by the user over time. This can leave helpful features unutilized or cause distracting features to be enabled. Another problem is that a different user may change a particular setting without the primary user's knowledge.

These and other problems with application program settings have left a need for an improved method of managing application program settings. It would be desirable if the improved method enabled an application user to have more control over the settings and the capability of using settings more frequently and efficiently to achieve various tasks. It would also be desirable if the method provided a more active interaction with the user.

### SUMMARY OF THE INVENTION

The present invention provides a method for managing temporary settings in an application program and a computer program product including instructions embodied on a computer readable medium for performing the method. The method comprises detecting that a new application setting has been entered by a user into the application program, automatically querying the user to designate the new setting as a default setting or a temporary setting in response to detecting the entry of the new setting, automatically querying the user to designate an expiration condition for a new setting designated as a temporary setting, operating the application program using the temporary setting until occurrence of the expiration condition; and operating the application program using the default setting in response to the occurrence of the expiration condition. Examples of an expiration condition include a time period, such as an hour or a day, or the expiration condition may be an event, such as closing a task pane, closing a document, closing the instantiation of the application, or using the temporary setting more than a set point number of times.

In one embodiment, the method further comprises retaining the temporary setting beyond expiration of the temporary setting, and providing the expired temporary setting as a suggested setting value in response to subsequent attempts to enter a new setting. In another embodiment, the method further comprises retaining the expiration condition beyond occurrence of the expiration condition, and providing the expiration condition as a suggested expiration condition in response to subsequent designation of temporary setting.

Furthermore, the method may provide user notifications. For example, the method may automatically notify the user that the temporary setting has expired or is about to expire. Such an automatic notification may include the value of the temporary setting and value of the default setting. Similarly, the method may automatically query the user to designate a new expiration condition prior to operating the application program with the default setting.

### BRIEF DESCRIPTION OF THE DRAWINGS

FIG. 1 is a logic diagram for a method of managing temporary application program settings.

FIG. 2 is an illustration of a settings window and a pop-up dialog box requesting user instructions whether to make a setting change permanent or temporary.

FIG. 3 is a block diagram of an application program including various objects for implementing the present invention.

FIG. 4 is a schematic diagram of an exemplary computer system that is suitable for executing a computer program product that includes instructions for managing temporary application program settings.

### DETAILED DESCRIPTION

The present invention provides a method and computer program product for managing temporary application program settings. A user may alter the application program settings in order to access or disable various features or functions of the application program. The ability to specify and save application program settings allows the user to tailor the application to best suit the user's objectives.

An application program will typically have default setting values provided by the application program vendor or setting values subsequently saved by the application program user. These default setting values are used by the application during startup of the application or when invoked by a user command. For example, in a word processing application program, a default setting that specifies the type of menu bars to be displayed would typically be invoked during application startup. By contrast, the same word processing application program may have a default setting that specifies how spelling errors are to be handled during a spell checking process. This default setting might not be invoked until the user has activated the command that initiates the spell checking process.

The method includes detecting that a new application setting has been entered by a user into the application program. Typically, an application menu allows the user to select a settings dialog box, locate a specific setting, and enter a new setting value. The new setting value is still not entered until the user verifies that the setting should be changed, such as by clicking on an “OK” button within the dialog box. In the present method, clicking on the “OK” button is an event that is detected by the application.

In response to this event, i.e., the entry of a new setting, the application provides a pop-up box that queries the user to designate the new setting as either a default setting or a temporary setting. If the user designates the setting as a default setting, then the setting value is used by the application in all subsequent instances until and unless the setting is eventually changed by the user.

However, if the new setting is designated as a temporary setting, then the application will automatically query the user to designate an expiration condition. Non-limiting examples of an expiration condition include a time period, such as an hour or a day, or the expiration condition may be an event, such as closing a task pane, closing a document, closing the instantiation of the application, or using the temporary setting more than a set point number of times. In one embodiment, the method allows the user to select from among several common time periods or events upon which to expire the setting. The list of suggested expiration conditions may be provided in a drop-down box and may include various conditions specified by the application vendor or user-specified conditions that have been previously used as expiration conditions. Typically, the user will be required to verify that the current content of the pop-up box are to be entered, such as by clicking on an “OK” button within the pop-up box. This should also serve to close the pop-up box.

The method then includes operating the application program using the temporary setting until occurrence of the expiration condition. Accordingly, the application may save the temporary setting value as the default setting in the configuration file and copy the previous default setting value to a temporary register in order to be able to replace the previous default setting value upon the occurrence of the expiration condition. An alternative technique includes the maintaining all of the default settings in the configuration file, create a temporary configuration file that includes any active temporary settings and their corresponding expiration conditions, and programming the application program to identify and use any temporary setting rather than the default setting. Other techniques for temporarily using one value instead of another value can be envisioned.

The occurrence of the expiration condition may be determined by an event listener object. The event listener may monitor a variety of conditions, such as a time period or an event. The event listener is programmed to monitor certain types of conditions and may offer these conditions to the user as selectable conditions for expiration of the temporary setting.

Finally, in response to the occurrence of the expiration condition, the application program then operates using the default setting. As described above, this may involve writing a previous default setting value from a temporary register back into the configuration file. Alternatively, this may involve deleting the temporary setting value from a temporary configuration file or even deleting the temporary configuration file. Other techniques for restoring the previous default setting value instead of the temporary value can be envisioned.

In one embodiment, the temporary setting is deleted upon expiration of the expiration condition. Alternatively, the temporary setting may be deactivated, but not deleted. A deactivated temporary setting may be used, for example, in future drop-down menus when the user attempts to change the setting in the future.

In yet another embodiment, the application program may also provide an administrative control that prevents a user from making permanent changes to the application settings unless the user has a require authority level or password. Accordingly, the pop-up box would default to a temporary setting, unless the user designated the setting as a permanent setting and provided a password as evidence of sufficient authority to make a permanent setting change. Such an administrative control feature would prove to be particularly beneficial where the application is used by a large number of users in order to maintain some common settings.

Is should be apparent that the method of the present invention may be used simultaneously with respect to multiple settings within the application program. Accordingly, the application may store multiple temporary settings and instruct the event listener to monitor for multiple expiration conditions. Upon occurrence of a particular expiration condition, the corresponding temporary setting is deactivated in favor of the previous default setting. The method may also allow for managing temporary settings that are specific to a particular instantiation of the application on a single computer or over a network.

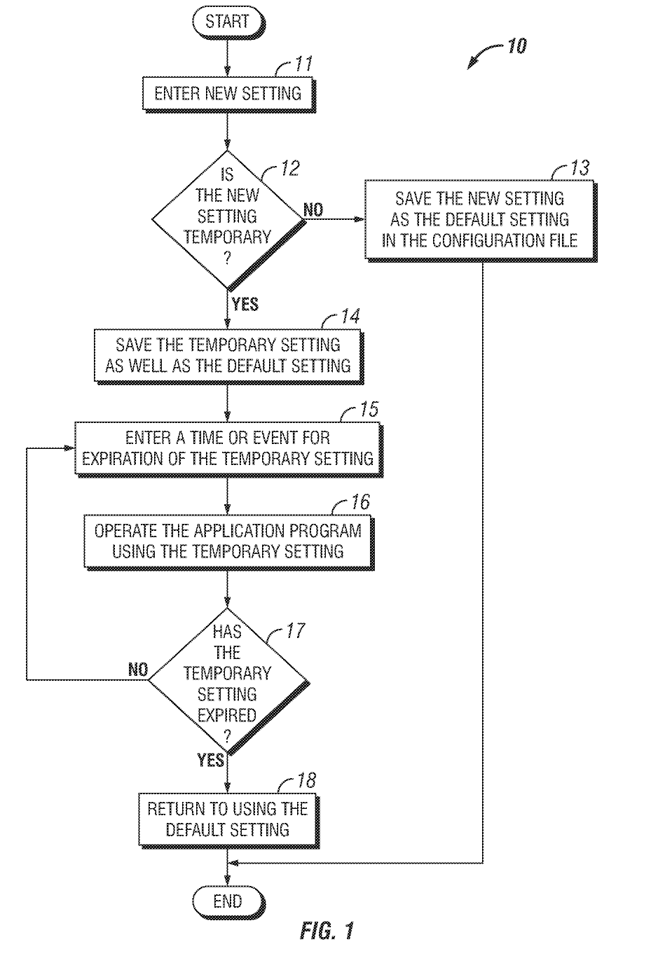

FIG. 1 is a logic diagram for a method 10 of managing temporary application program settings. In state 11, the user enters a new setting into the application program, such as through a dialog box. In state 12, the application determines whether the user intends for the new setting to be temporary. If the new setting is not temporary, then in state 13 the new setting is saved as the default setting in the configuration file. However, if the new setting is in fact temporary, then in state 14 the temporary setting and the previous default setting are both saved. In state 15, the application prompts the user to enter an expiration condition, such as a time or event, for expiration of the temporary setting. Typically, the user will verify the accuracy of the information before the temporary setting is saved and activated.

Having activated the temporary setting in state 15, the application program will operate using the temporary setting in state 16. In state 17, the application program will continue to operate with the temporary setting until it is determined that the temporary setting has expired. Upon determining that the temporary setting has expired in state 17, the application program will return to operating with the previous default setting. As described above, the temporary setting was utilized until the expiration condition was met.

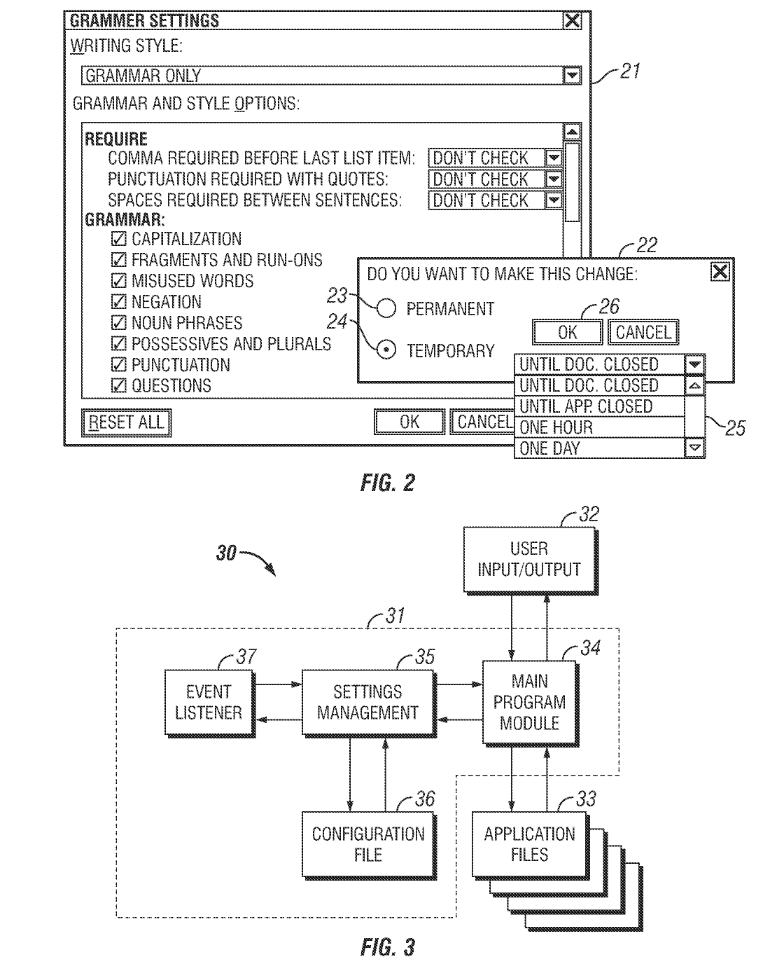

FIG. 2 is an illustration of a display screen 20 having a settings window 21 and a pop-up dialog box 22 requesting user instructions whether to make a setting change permanent (as indicated by clicking the bubble 23) or temporary (as indicated by clicking bubble 24). If the setting change is temporary, as indicated by clicking bubble 24, then a drop down box 25 is activated to offer the user some choices of an expiration condition. While the expiration conditions may be selected only from a group of predetermined conditions, it is also possible that the user could specify a unique condition using a set of acceptable commands and variables. For example, a user might enter an expiration date by entering a command line “UNTIL DATE>09-30-2006”. Upon completion of the either the permanent or temporary selections, the user would click the “OK” button 26 to enter activate the temporary setting until the occurrence of the expiration condition.

FIG. 3 is a block diagram 30 of an application program 31 including various objects for implementing the present invention. The application program communicates with user input and output devices 32 in order to obtain user instructions and provide a user interface. The application program also creates and stores one or more application files 33 which store data specific to a file or document created as a result of user interaction with the program. The application program 31 includes a main program module 34 which handles and executes the primary features and functions of the application program. The main program module 34 obtains current settings from, and provides new setting information to, the settings management module 35. In turn, the settings management module retrieves stored settings data from the configuration file 36 and stores new settings in the configuration file 36. Depending upon the exact implementation, the settings management module 35 may store temporary settings into the configuration file 36 or a temporary configuration file (not shown). The settings management module 35 is also responsible for interfacing with the event listener 37 that monitors for the occurrence of expiration conditions that are applicable to temporary settings that are currently activated. The application program 31 is just one of many program structures that may be used to implement the present invention. Other similar or disparate program structures will be apparent to those skilled in the art after reading the present disclosure.

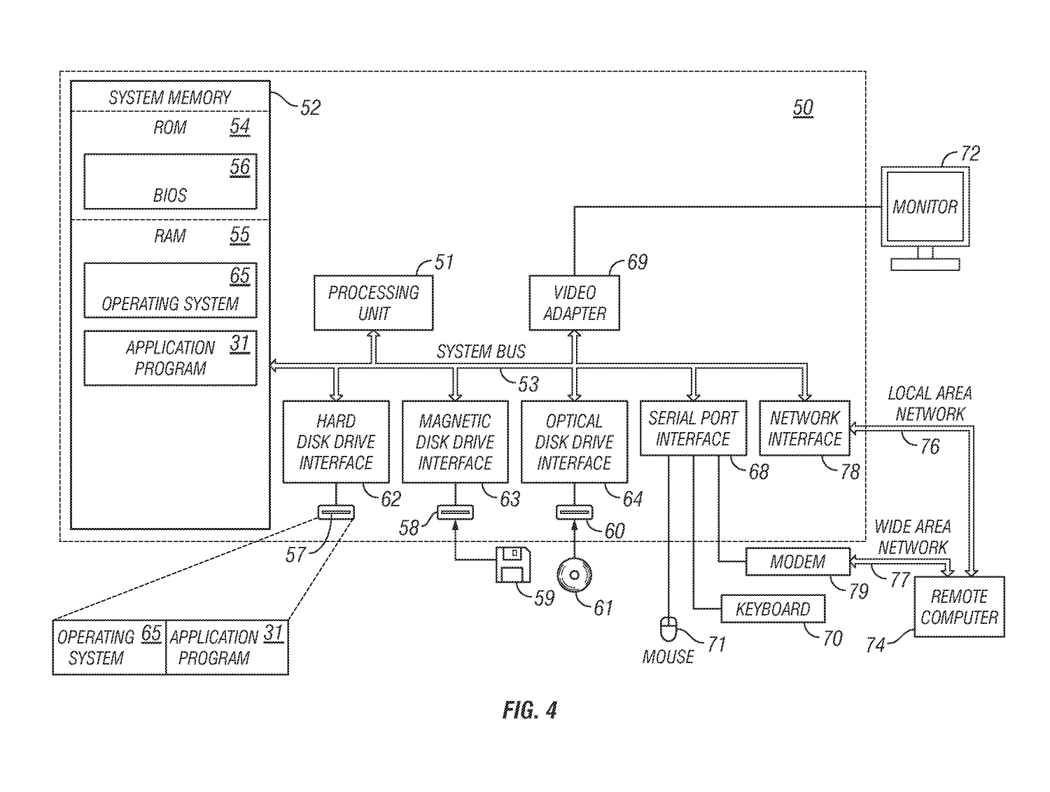

FIG. 4 is a schematic diagram of an exemplary computer system 50 that is suitable for executing a computer program product that includes instructions for managing temporary application program settings. The system 50 may be a general-purpose computing device in the form of a conventional personal computer 50. Generally, a personal computer 50 includes a processing unit 51, a system memory 52, and a system bus 53 that couples various system components including the system memory 52 to processing unit 51. System bus 53 may be any of several types of bus structures including a memory bus or memory controller, a peripheral bus, and a local bus using any of a variety of bus architectures. The system memory includes a read-only memory (ROM) 54 and random-access memory (RAM) 55. A basic input/output system (BIOS) 56, containing the basic routines that help to transfer information between elements within personal computer 50, such as during start-up, is stored in ROM 54.

Computer 50 further includes a hard disk drive 57 for reading from and writing to a hard disk 57, a magnetic disk drive 58 for reading from or writing to a removable magnetic disk 59, and an optical disk drive 60 for reading from or writing to a removable optical disk 61 such as a CD-ROM or other optical media. Hard disk drive 57, magnetic disk drive 58, and optical disk drive 60 are connected to system bus 53 by a hard disk drive interface 62, a magnetic disk drive interface 63, and an optical disk drive interface 64, respectively. Although the exemplary environment described herein employs hard disk 57, removable magnetic disk 59, and removable optical disk 61, it should be appreciated by those skilled in the art that other types of computer readable media which can store data that is accessible by a computer, such as magnetic cassettes, flash memory cards, digital video disks, Bernoulli cartridges, RAMs, ROMs, and the like, may also be used in the exemplary operating environment. The drives and their associated computer readable media provide nonvolatile storage of computer-executable instructions, data structures, program modules, and other data for computer 50. For example, the operating system 65 and the application program 31 for executing the method 10, may be stored in the hard disk 57 or in RAM 55 of the computer 50.

A user may enter commands and information into personal computer 50 through input devices, such as a keyboard 70 and a pointing device, such as a mouse 71. Other input devices (not shown) may include a microphone, joystick, game pad, satellite dish, scanner, or the like. These and other input devices are often connected to processing unit 51 through a serial port interface 68 that is coupled to the system bus 53, but input devices may be connected by other interfaces, such as a parallel port, game port, a universal serial bus (USB), or the like. A display device 72 may also be connected to system bus 53 via an interface, such as a video adapter 69. In addition to the monitor, personal computers typically include other peripheral output devices (not shown), such as speakers and printers.

The computer 50 may operate in a networked environment using logical connections to one or more remote computers 74. Remote computer 74 may be another personal computer, a server, a client, a router, a network PC, a peer device, a mainframe, a personal digital assistant, an Internet-connected mobile telephone or other common network node. The remote computer 74 typically includes many or all of the elements described above relative to the computer 50. The logical connections depicted in the figure include a local area network (LAN) 76 and/or a wide area network (WAN) 77. Such networking environments are commonplace in offices, enterprise-wide computer networks, intranets, and the Internet.

When used in a LAN networking environment, the computer 50 is often connected to the local area network 76 through a network interface or adapter 78. When used in a WAN networking environment, the computer 50 typically includes a modem 79 or other means for establishing high-speed communications over WAN 77, such as the Internet. A modem 79, which may be internal or external, is connected to system bus 53 via serial port interface 68. In a networked environment, program modules depicted relative to personal computer 50, or portions thereof, may be stored in the remote memory storage device 75. It will be appreciated that the network connections shown are exemplary and other means of establishing a communications link between the computers may be used. A number of program modules may be stored on hard disk 57, magnetic disk 59, optical disk 61, ROM 54, or RAM 55, including an operating system 65 and browser 66.

The device shown in FIG. 4 should not imply that the invention has architectural limitations. For example, those skilled in the art will appreciate that the present invention may be implemented in other computer system configurations, including hand-held devices, multiprocessor systems, microprocessor based or programmable consumer electronics, network personal computers, minicomputers, mainframe computers, and the like. The invention may also be practiced in distributed computing environments, where tasks are performed by remote processing devices that are linked through a communications network. In a distributed computing environment, program modules may be located in both local and remote memory storage devices.

It should be recognized that the method of the present invention may be implemented in any application program that allows the user to alter settings. The application program is not limited to a particular programming language or operating environment.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for managing temporary settings in an application program, comprising:
detecting that a new application setting has been entered by a user into the application program;
automatically querying the user to designate the new setting as a default setting or a temporary setting in response to detecting the entry of the new setting;
automatically querying the user to designate an expiration condition for a new setting designated as a temporary setting;
operating the application program using the temporary setting until occurrence of the expiration condition; and
operating the application program using the default setting in response to the occurrence of the expiration condition.

2. The method of claim 1, wherein the expiration condition is selected from a time period or an event.

3. The method of claim 1, wherein the expiration condition is an event.

4. The method of claim 3, wherein the event is selected from closing a task pane, closing a document, or closing the instantiation of the application.

5. The method of claim 3, wherein the event is the temporary setting having been used more than a set point number of times.

6. The method of claim 1, further comprising:
retaining the temporary setting beyond expiration of the temporary setting; and
providing the expired temporary setting as a suggested setting value in response to subsequent attempts to enter a new setting.

7. The method of claim 1, further comprising:
retaining the expiration condition beyond occurrence of the expiration condition; and
providing the expiration condition as a suggested expiration condition in response to subsequent designation of temporary setting.

8. The method of claim 1, further comprising:
automatically notifying the user that the temporary setting has expired or is about to expire.

9. The method of claim 8, wherein the automatic notification includes the value of the temporary setting and value of the default setting.

10. The method of claim 1, further comprising:
automatically querying the user to designate a new expiration condition prior to operating the application program with the default setting.

11. A computer program product including instructions embodied on a computer readable medium for managing temporary settings in an application program, the instructions comprising:
instructions for detecting that a new application setting has been entered by a user into the application program;
instructions for automatically querying the user to designate the new setting as a default setting or a temporary setting in response to detecting the entry of the new setting;
instructions for automatically querying the user to designate an expiration condition for a new setting designated as a temporary setting;
instructions for operating the application program using the temporary setting until occurrence of the expiration condition; and
instructions for operating the application program using the default setting in response to the occurrence of the expiration condition.

12. The computer program product of claim 11, wherein the expiration condition is selected from a time period or an event.

13. The computer program product of claim 1 1, wherein the expiration condition is an event.

14. The computer program product of claim 13, wherein the event is selected from closing a task pane, closing a document, or closing the instantiation of the application.

15. The computer program product of claim 13, wherein the event is the temporary setting having been used more than a set point number of times.

16. The computer program product of claim 11, further comprising:
instructions for retaining the temporary setting beyond expiration of the temporary setting; and
instructions for providing the expired temporary setting as a suggested setting value in response to subsequent attempts to enter a new setting.

17. The computer program product of claim 11, further comprising:
instructions for retaining the expiration condition beyond occurrence of the expiration condition; and
instructions for providing the expiration condition as a suggested expiration condition in response to subsequent designation of temporary setting.

18. The computer program product of claim 1 1, further comprising:
instructions for automatically notifying the user that the temporary setting has expired or is about to expire.

19. The computer program product of claim 18, wherein the automatic notification includes the value of the temporary setting and value of the default setting.

20. The computer program product of claim 11, further comprising:
instructions for automatically querying the user to designate a new expiration condition prior to operating the application program with the default setting.
